(19) United States
(12) Patent Application Publication
(10) Pub. No.: US 2004/0003931 A1
(43) Pub. Date: Jan. 8, 2004

(54) Machine-tool, in particular drilling and/or chipping hammer

(76) Inventors: Rolf Mueller, Leinfelden-Echterdingen (DE); Dietmar Saur, Gomaringen (DE)

Correspondence Address: Striker Striker & Stenby, 103 East Neck Road, Huntington, NY, 11743, US

(21) Appl. No.: 10/398,054

(22) PCT Filed: Mar. 14, 2002
(86) PCT No.: PCT/DE02/00889

(30) Foreign Application Priority Data
Aug. 16, 2001 (DE) 101 40 319.4

(51) Int. Cl. B25D 9/00

(52) U.S. Cl. 173/90

(57) ABSTRACT

The invention is based on a hand power tool, in particular a drilling or chipping hammer, comprising a striking mechanism having a drive end bearing (12, 58) that is turnably supported on an intermediate shaft (10), via which a piston (14) is capable of being driven in reciprocating fashion in the axial direction.

It is proposed that the drive end bearing (12) is supported by a radial bearing (16) in at least one axial direction via the intermediate shaft (10).

### BACKGROUND OF THE INVENTION

The invention is based on a hand power tool, in particular a drilling and/or chipping hammer, according to the preamble of claim 1.

A drilling and chipping hammer having a striking mechanism that comprises a drive end bearing is generally known. The drive end bearing comprises a structure that is turnably supported on an intermediate shaft, which said structure comprises a ground-in ball track in its radially outer region, which said ball track is located in a plane that is tilted in the axial direction of the intermediate shaft. The structure is capable of being driven in rotating fashion via a separable clutch.

A functional unit of the drive end bearing is situated on the structure with an annular bearing seat and a bolt, which said functional unit is turnably interconnected with the structure via balls guided in the ball track. The bolt of the functional unit is displaceably supported in a cross hole of a pivotably supported cross bolt of a piston of the striking mechanism and, as a result of this, is interconnected with the piston in driving fashion.

If the drilling and chipping hammer is operated in the striking mode, the structure is driven in rotating fashion, and the bolt of the functional unit and the piston are moved in reciprocating fashion in the axial direction, which produces an alternating axial load on the drive end bearing. A ball track of a grooved ball bearing is ground in a radially outer region in the structure of the drive end bearing on a side furthest from a tool mount, via which said grooved ball bearing the drive end bearing is fixed in position in both axial directions in a housing of the drilling and chipping hammer.

### ADVANTAGES OF THE INVENTION

The invention is based on a hand power tool, in particular a drilling and/or chipping hammer, comprising a striking mechanism having a drive end bearing turnably supported on an intermediate shaft, via which said drive end bearing a piston is capable of being driven in reciprocating fashion in the axial direction.

It is proposed that the drive end bearing be supported by a radial bearing in at least one axial direction via the intermediate shaft. An exact positioning of the drive end bearing on the intermediate shaft can be obtained, and the drive end bearing can be pre-mounted on the intermediate shaft using simple design means, and it can be installed—mounted on the intermediate shaft—in the hand power tool. If the drive end bearing is supported by a radial bearing that can absorb axial forces in two directions, additional components and space can be saved in particular.

Space can be further saved by locating the radial bearing in an inner region of a structure of the drive end bearing, and particularly so when a space containing the radial bearing overlaps a space containing a functional unit of the drive end bearing in the axial direction.

The radial bearing can be formed, basically, by a sliding bearing. If the radial bearing is formed by a rolling bearing, however, a competitively-priced component can be used that has minimal friction due to the fact that rolling elements roll around, and an advantageous no-load characteristic of the drive end bearing can be obtained.

In a further embodiment of the invention it is proposed that the radial bearing be mounted on the intermediate shaft by means of a press fit. The drive end bearing is capable of being supported in the axial direction on the intermediate shaft using simple design means via the press fit. The radial bearing can also be interconnected with the intermediate shaft via other connections having non-positive, positive and/or bonded engagement appearing reasonable to one skilled in the art, e.g., via a circlip, a ball track ground in the intermediate shaft, a non-positive retainer, etc.

It is further proposed that the intermediate shaft and/or the drive end bearing form a part of the radial bearing, in fact by the fact that a ball track is ground in the intermediate shaft and/or in the drive end bearing and/or the structure of the drive end bearing. Additional components, space, weight, assembly expenditure and costs can be saved.

Particularly advantageously, arising axial forces are capable of being transmitted in at least one direction via the radial bearing to at least one component mounted on the intermediate shaft. A design can be obtained with which the axial forces—compression forces, in particular—can be supported particularly advantageously via the adjacent component on the intermediate shaft and via the intermediate shaft in a housing. As a result, the mounting of the radial bearing itself can be advantageously designed to absorb the forces in one axial direction, which are not as great. If the radial bearing is mounted on the intermediate shaft with non-positive engagement via a press fit, said radial bearing can be pressed onto the intermediate shaft with minimal deformation, and small tolerances can be achieved.

The component that is located on the intermediate shaft and absorbs axial forces can be formed by a retainer mounted on the intermediate shaft with positive, non-positive and/or bonded engagement, or by another component appearing reasonable to one skilled in the art. If the rolling bearing is located on a side of the drive end bearing furthest away from a tool mount, an advantageous utilization of space can be achieved and, in particular, a component that is already present—a gear, in particular—can be used for additional axial support using simple design means, and additional components can be saved.

### SUMMARY OF THE DRAWINGS

Further advantages result from the following description of the drawings. Exemplary embodiments of the invention are presented in the drawings. The drawings, the description, and the claims contain numerous features in combination. One skilled in the art will advantageously consider them individually as well and combine them into reasonable further combinations.

FIG. 1 is a schematic illustration of a drilling and chipping hammer,

FIG. 2 is an enlarged section II in FIG. 1, and

FIG. 3 is a variant of FIG. 2.

### DESCRIPTION OF THE PREFERRED EMBODIMENTS

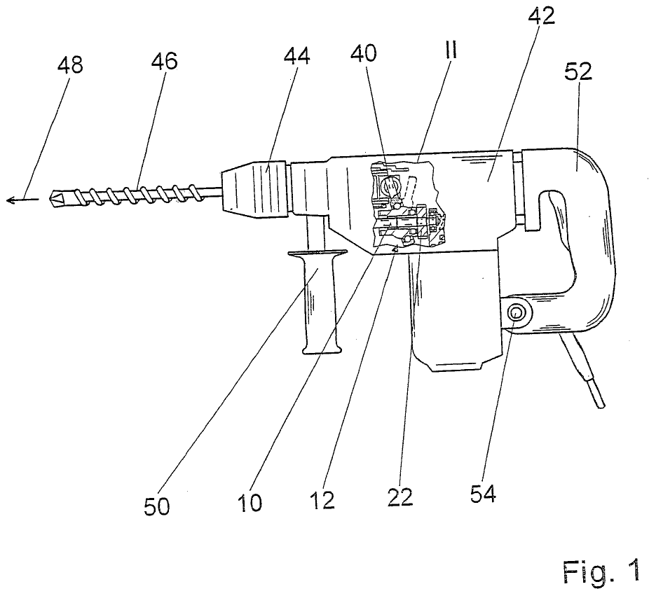

FIG. 1 is a schematic illustration of a drilling and chipping hammer having a not-shown electric motor in a housing 42, as well as a gearbox and a striking mechanism. A first handle 50 extending at a right angle to the operating direction 48 is mounted on the housing 42 behind the tool mount 44 against an operating direction 48. A second, U-shaped handle 52 extending at a right angle to the operating direction 48 is located on the side of the housing 42 furthest from the tool 46, which said handle is interconnected with the housing 42 at its first end furthest from a tool axis via a hinge joint 54 having a pivot axis extending transversely to the operating direction 48. At its second end, the handle 52 is interconnected with the housing 42 via a vibration-isolating device.

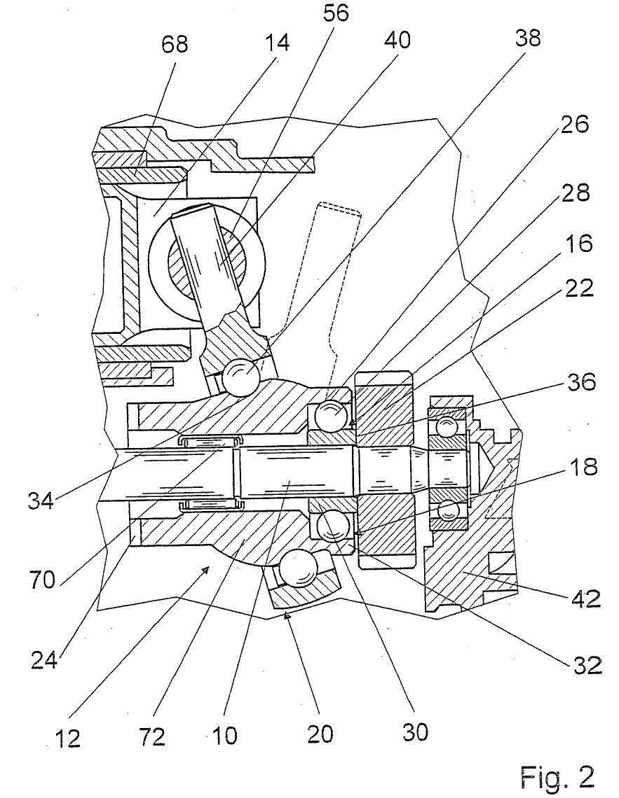

The electric motor has a drive shaft on which a pinion is integrally molded. The pinion meshes with a spur gear 22 that is situated in torsion-resistant fashion on an intermediate shaft 10 on a side furthest from a tool mount 44 (FIG. 2). By means of the intermediate shaft 10, a drill bit 46 held in the tool mount 44 is capable of being driven in striking fashion via the striking mechanism, and in rotating fashion via a work spindle 68 designed as hollow shaft.

A drive end bearing 12 is located on a side of the spur gear 22 closest to the tool mount 44, which said drive end bearing comprises a structure 72 that is situated on the intermediate shaft 10 in a manner that allows it to rotate via a needle bearing 70. The structure 72 comprises an integrally-molded, turnably driving tooth system 24 on its end face closest to the tool mount 44. A collar 32 extending in the axial direction is integrally molded on the structure 72 on an end face furthest from the tool mount 44, in the radially inner region 18 of which said collar a radial bearing 16 designed as grooved ball bearing is located. The collar 32 forms a part of the radial bearing 16, the rolling elements 28—designed as balls—of which roll radially outwardly around in a ball track 26 ground in a radially inwardly-facing side of the collar 32. Radially inwardly, the rolling elements 28 roll around in a bearing inner race 30 of the radial bearing 16.

The bearing inner race 30 mounted on the intermediate shaft 10 with non-positive engagement in the axial direction by means of a press fit bears against the spur gear 22 with its side 36 furthest from the tool mount 44, which said spur gear is also mounted on the intermediate shaft 10 by means of a press fit. The bearing inner race 30 and the spur gear 22 are pressed onto the intermediate shaft 10 in the same process step.

In its radially outer region, the structure 72 comprises a ground-in ball track 34 that is located in a plane that is tilted in the axial direction of the intermediate shaft 10. A functional unit 20 with an annular bearing seat and a bolt 40 is located on the structure 72, which said functional unit is turnably interconnected with the structure 72 via balls 38 guided in the ball track 34, whereby a space containing the radial bearing 16 and a space containing the functional unit 20 overlap in the axial direction. The bolt 40 of the functional unit 20 is displaceably supported in a cross hole of a pivotably supported cross bolt 56 of a piston 14. If the structure 72 is driven in rotating fashion via the turnably driving tooth system 24 within the functional unit 20 that is standing still in the direction of rotation, the bolt 40 of the functional unit 20 executes a reciprocating motion and drives the piston 14 in reciprocating fashion in the axial direction.

If the piston 14 is moved in the direction away from the tool mount 44 via the bolt 40 of the functional unit 20 of the drive end bearing 12, an air cushion located in the work spindle 68 is expanded, whereby the drive end bearing 12 is braced, via its structure 72, in the direction toward the tool mount 44 via the bearing inner race 30 of the radial bearing 16 and via the intermediate shaft 10 in the housing 42. The press fit of the bearing inner race 30 is designed to withstand a first bracing force that occurs under these circumstances.

If the piston 14 is moved via the bolt 40 of the functional unit 20 of the drive end bearing 12 in the direction toward the tool mount 44, an air cushion located in the work spindle 68 is compressed, whereby the drive end bearing 12 is braced, via its structure 72, in the direction away from the tool mount 44 via the bearing inner race 30 of the radial bearing 16, the spur gear 22 on the intermediate shaft 10, and via the intermediate shaft 10 in the housing 42. A second bracing force—that is greater than the first bracing force—generated as a result is transmitted to the intermediate shaft 10 by means of the press fits of the bearing inner race 30 and the spur gear 22, the effects of which complement each other.

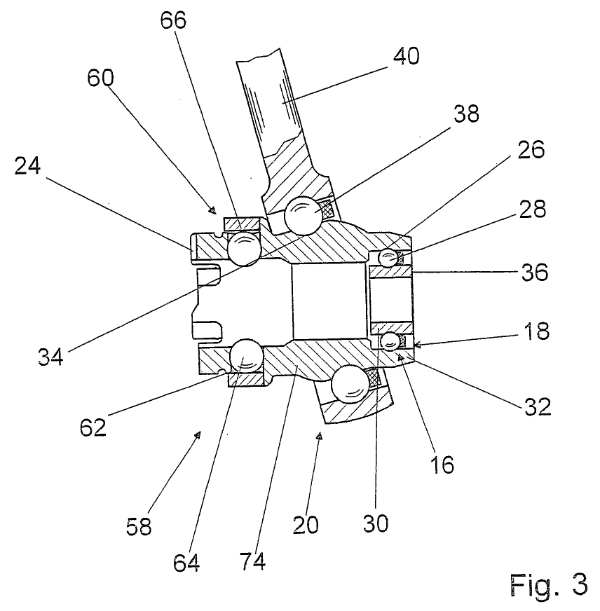

FIG. 3 shows a section of an alternative drilling and chipping hammer having a drive end bearing 58. Components that essentially remain the same are basically labelled with the same reference numerals. Moreover, the description of the exemplary embodiment shown in FIGS. 1 and 2 can be referred to with regard for features and functions that remain the same. The following description is essentially limited to the differences from the exemplary embodiment shown in FIGS. 1 and 2.

On its side closest to the tool mount 44, a structure 74 of the drive end bearing 58 comprises radial holes 62 in an anterior region in which turnably driving balls 64 are located. The turnably driving balls 64 are enclosed radially by an annular spring 66 that loads the turnably driving balls 64 radially inwardly. During a coupling process, the turnably driving balls 64 correspond with recesses in a not-shown turnably driving element situated in torsion-resistant fashion on an intermediate shaft, and a purposeful build-up of torque can be achieved.

### REFERENCE NUMERALS

10 Intermediate shaft

12 Drive end bearing

14 Piston

16 Radial bearing

18 Radial Region

20 Functional unit

22 Component

24 Turnably driving tooth system

26 Ball track

28 Rolling element

30 Bearing inner race

32 Collar

34 Ball track

36 Side

38 Ball

40 Bolt

42 Housing

44 Tool mount

46 Tool

48 Operating direction

50 Handle

52 Handle

54 Hinged joint

56 Cross bolt

58 Drive end bearing

60 Region

62 Radial hole

64 Turnably driving ball

66 Annular spring

68 Work spindle

70 Needle bearing

72 Structure

74 Structure

What is claimed is:

1. A hand power tool, in particular a drilling and/or chipping hammer, comprising a striking mechanism having a drive end bearing (12, 58) that is turnably supported on an intermediate shaft (10), via which a piston (14) is capable of being driven in reciprocating fashion in the axial direction, wherein the drive end bearing (12) is supported in at least one axial direction by a radial bearing (16) via the intermediate shaft (10).

2. The hand power tool according to claim 1,
wherein the radial bearing (16) is formed by a rolling bearing.

3. The hand power tool according to claim 1 or 2,
wherein the radial bearing (16) is located in a radially inner region (18) of a structure (72, 74) of the drive end bearing (12, 58).

4. The hand power tool according to claim 3,
wherein a space containing the radial bearing (16) overlaps a space containing a functional unit (20) of the drive end bearing (12, 58) in the axial direction.

5. The hand power tool according to one of the claims 3 or 4,
wherein the radial bearing (16) is fixed in position on the intermediate shaft (10) by means of a press fit.

6. The hand power tool according to one of the claims 3 or 4,
wherein the intermediate shaft (10) forms a part of the radial bearing (16).

7. The hand power tool according to one of the preceding claims,
wherein the drive end bearing (12, 58) forms a part of the radial bearing (16).

8. The hand power tool according to one of the preceding claims,
wherein arising axial forces are capable of being transmitted in at least one direction via the radial bearing (16) to at least one component (22) mounted on the intermediate shaft (10).

9. The hand power tool according to one of the preceding claims,
wherein the radial bearing (16) is located on a side of the drive end bearing (12, 58) furthest away from a tool mount (44).

10. The hand power tool according to claim 8 and 9,
wherein the component (22) mounted on the intermediate shaft (10) is a gear (22).

11. A hand power tool, in particular a drilling and/or chipping hammer, comprising a striking mechanism having a drive end bearing (12, 58) that is turnably supported on an intermediate shaft (10), via which a piston (14) is capable of being driven in reciprocating fashion in the axial direction, wherein the drive end bearing (12) is supported in at least one axial direction by a radial bearing (16) via the intermediate shaft (10).

12. The hand power tool according to claim 11,
wherein the radial bearing (16) is formed by a rolling bearing.

13. The hand power tool according to claim 11,
wherein the radial bearing (16) is located in a radially inner region (18) of a structure (72, 74) of the drive end bearing (12, 58).

14. The hand power tool according to claim 13,
wherein a space containing the radial bearing (16) overlaps a space containing a functional unit (20) of the drive end bearing (12, 58) in the axial direction.

15. The hand power tool according to claim 13,
wherein the radial bearing (16) is fixed in position on the intermediate shaft (10) by means of a press fit.

16. The hand power tool according to claim 13,
wherein the intermediate shaft (10) forms a part of the radial bearing (16).

17. The hand power tool according to claim 11,
wherein the drive end bearing (12, 58) forms a part of the radial bearing (16).

18. The hand power tool according to claim 11,
wherein arising axial forces are capable of being transmitted in at least one direction via the radial bearing (16) to at least one component (22) mounted on the intermediate shaft (10).

19. The hand power tool according to claim 11,
wherein the radial bearing (16) is located on a side of the drive end bearing (12, 58) furthest away from a tool mount (44).

20. The hand power tool according to claim 18,
wherein the component (22) mounted on the intermediate shaft (10) is a gear (22).
